(19) United States
(12) Patent Application Publication
(10) Pub. No.: US 2003/0065952 A1
(43) Pub. Date: Apr. 3, 2003

(54) Authentication system using device address to verify authenticity of terminal

(75) Inventor: Naoki Otsuka, Konan-shi (JP)

Correspondence Address: OLIFF & BERRIDGE, PLC, P.O. BOX 19928, ALEXANDRIA, VA, 22320, US

(73) Assignee: Brother Kogyo Kabushiki Kaisha, Nagoya-shi (JP)

(21) Appl. No.: 10/254,603

(22) Filed: Sep. 26, 2002

(30) Foreign Application Priority Data
Sep. 28, 2001 (JP) 2001-300378

(51) Int. Cl. G06F 11/30

(52) U.S. Cl. 713/201; 709/223

(57) ABSTRACT

An authenticator displays identification information based on device addresses transmitted from terminals. A user selects a terminal among the terminals based on the displayed identification information. A device address of the selected terminal is transmitted to a service providing device, and then added to a registration list. When a service providing device receives a service request from a terminal, the service providing device provides a requested service to the terminal if the device address of the terminal is listed in the registration list.

### BACKGROUND OF THE INVENTION

1. Field of the Invention

The present invention relates to an authentication system for authenticating terminals that request a service providing device for services.

2. Related Art

An authentication system has been used in a computer or network system for verifying authenticity of terminals that request for permission to access the computer system or to receive various services from the computer system, in order to assure security of the systems by controlling the access to the computer system or preventing the computer system from being abused.

One example of authentication mechanisms uses user names and passwords. An authentic user who is allowed for accessing or receiving services from a computer system is given a user name, which is registered along with a password known to nobody but the authentic user. Then, an authentication device verifies authenticity of the user by whether or not the user subjected to authentication knows the user name and the password. Such user names and passwords are registered in a computer or a network server that controls the computer system by a system manager.

Recently, there have been provided terminals that include a Bluetooth interface or an IEEE802.11b (IEEE802.11 High-Rate Direct Sequence) interface. Bluetooth is a name of a short-range radio frequency technology. When such a terminal is located within a communication range of a computer system that uses a radio interface of the same kind, then a communication network is easily established between the terminal and the computer system, enabling the terminal to access the computer system and also to receive various services therefrom.

For example, in FIG. 6, a communication network can be established between a computer system provided in a restricted room A and a terminal 50d that is located outside the room A but within a communication range α of the computer system. Accordingly, a user of the terminal 50d can access the computer system without permission. In order to overcome this problem, such a network system is usually provided with an authentication system for verifying authenticity of terminals, such as the terminal 50d, having the above interface.

### SUMMARY OF THE INVENTION

However, adopting the authentication system in this network system places a burden on a system manager who registers user names and passwords for new users.

For example, although a security level of the computer system of FIG. 6 against persons authorized to access the room A may not need to be as high as that against unauthorized persons, a system manager needs to register user names and passwords of all the persons regardless of a required security level, i.e., whether they are authorized or unauthorized to enter the room A. This is a burdensome operation for the system manager.

It is an object of the present invention to overcome the above problems and to provide an authentication system where a user rather than a system manager can easily register selected terminals as authentic terminals.

In order to overcome the above problems, according to the present invention, there is provided an authentication system including a terminal assigned with an identifier that identifies the terminal, an authentication device communicable with the terminal, and a service providing device communicable both with the terminal and the authentication device. The terminal includes a first transmitting unit that transmits the identifier to the authentication device, a second transmitting unit that transmits the identifier to the service providing device, and a service requesting unit that requests the service providing device for a service. The authentication device includes a display unit that displays identification information based on the identifier transmitted from the first transmitting unit, a selecting unit that selects a terminal using the identification information displayed by the display unit, and a third transmitting unit that transmits an identifier of the selected terminal to the service providing device. The service providing device includes a memory that stores the identifier transmitted from the third transmitting unit, a determination unit that determines whether or not the identifier transmitted from the second transmitting unit is being stored in the memory, and a service providing unit that provides a requested service to a terminal if the determination unit determines that an identifier of the terminal is being stored in the memory.

There is also provided an authentication device communicable with a service providing device that provides a service to a terminal if permitted. The authentication device includes a display unit that displays identification information based on identifiers transmitted from terminals, each identifier identifying a corresponding terminal, a selection unit that selects a terminal among the terminals based on the identification information, and a permission unit that permits the service providing device to provide a service to the selected terminal by transmitting an identifier of the selected terminal.

Also, there is provided a service providing device including a memory that stores an identifier of a terminal transmitted from an authentication device, a determination unit that determines whether or not an identifier of a subject terminal is stored in the memory, and a service providing unit that provides service to the subject terminal if the determination unit determines that the identifier of the subject terminal is stored in the memory.

Further, there is provided an authentication system including a terminal assigned with an identifier that identifies the terminal, a service providing device communicable with the terminal, and an authentication device communicable with both the terminal and the service providing device. The terminal includes a first transmitting unit that transmits the identifier to the authentication device, a second transmitting unit that transmits the identifier to the service providing device, and a service requesting unit that transmits a service request requesting the service providing device for a service. The service providing device includes a third transmitting unit that transmits the identifier from the second transmitting unit to the authentication device, an authentication requesting unit that requests the authentication device for verify authenticity of a subject terminal by transmitting an identifier of the subject terminal to the authentication device, and a service providing device that provides the service to the subject terminal. The authentication device includes a display unit that displays identification information based on the identifier transmitted from at least one of the first transmitting unit and the third transmitting unit, a selecting unit that selects a terminal using the identification information displayed by the display unit, a memory that stores an identifier of the selected terminal, a determination unit that determines whether or not an identifier of a subject terminal transmitted from the authentication requesting unit of the service providing device is being stored in the memory, and a permitting unit that permits the service providing unit to provide the service to the subject terminal if the determination unit determines that the identifier of the subject terminal is being stored in the memory. The service providing unit provides the service to the subject terminal only when permitted by the permitting unit.

Moreover, there is provided an authentication device communicable with a service providing device that provides a service to a terminal. The authentication device includes a display unit that displays identification information based on identifiers transmitted from terminals and/or the service providing device, a selecting unit that selects a terminal among the terminals based on the identification information displayed by the display unit, a memory that stores an identifier of the selected terminal, a determination unit that determines whether or not an identifier transmitted from a service providing device is being stored in the memory, and a permission unit that permits the service providing device to provide the service to a subject terminal if the determination unit determines that an identifier of the subject terminal is being stored in the memory.

There is also provided a service providing device including a receiving unit that receives a service request from a terminal, a transmitting unit that transmits an identifier of the terminal to an authentication device, wherein the receiving unit further receives an authentication result from the authentication device that verifies authenticity of the terminal, and a determination unit that determines whether or not to provide a service to the terminal based on the authentication result.

### BRIEF DESCRIPTION OF THE DRAWINGS

In the drawings:

FIG. 1 is a block diagram showing an authentication system according to a first embodiment of the present invention;

FIG. 2 is a flowchart representing a terminal registration process executed by an authentication device of the authentication system of FIG. 1;

FIG. 3(a) is an example of a display showing a list of identification information;

FIG. 3(b) is another example of a display showing a list of identification information;

FIG. 3(c) is an example of a display where one terminal is selected from the list of FIG. 3(b);

FIG. 4 is a flowchart representing a service providing process executed by a service providing device of the authentication system of FIG. 1;

FIG. 5 is a flowchart representing a service requesting process executed by a terminal of the authentication system of FIG. 1;

FIG. 6 is an explanatory diagram showing one example of system where the authentication system of FIG. 1 is used;

FIG. 7 is a flowchart representing a device address deleting process executed by the service providing device;

FIG. 8 is a flowchart representing a terminal registration process according to a second embodiment of the present invention;

FIG. 9 is a terminal authentication process according to the second embodiment of the present invention; and

FIG. 10 is a service providing process according to the second embodiment of the present invention.

### PREFERRED EMBODIMENTS OF THE PRESENT INVENTION

Next, authentication systems according to embodiments of the present invention will be described while referring to attached drawings.

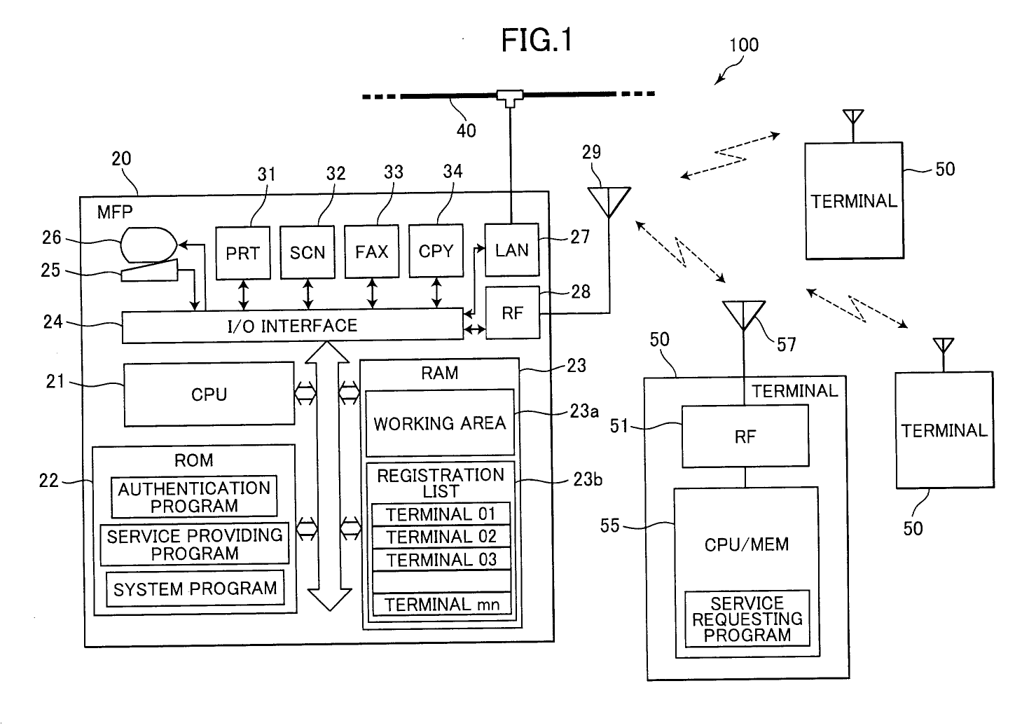

As shown in FIG. 1, an authentication system 100 according to a first embodiment of the present invention includes a multifunction peripheral (MFP) 20 and terminals 50. The MFP 20 functions both as a service providing device for providing various services, such as copying service, and as an authentication device for verifying authenticity of the terminals 50 that request the service providing device to provide services.

The MFP 20 includes a central processing unit (CPU) 21, a read only memory (ROM) 22, a random access memory (RAM) 23, an input/output (I/O) interface 24, an input key 25, a display 26, a LAN unit 27, a radio communication unit 28, and an antenna 29. The RAM 23 includes a working area 23a and stores a registration list 23b. The I/O interface 24 is connected to a printer unit 31, a scanner unit 32, a facsimile unit 33, and a copy unit 34.

In the present embodiment, the CPU 21, the ROM 22, the RAM 23, the I/O interface 24, the input key 25, the display 26, the LAN unit 27, the radio communication unit 28, and the antenna 29 together serve as the authentication device. Also, the CPU 21, the ROM 22, the RAM 23, the I/O interface 24, the printer unit 31, the scanner unit 32, the facsimile unit 33, and the copy unit 34 together serves as the service providing device.

The CPU 21 is for executing overall control of the MFP 20, and is connected to the ROM 22, the RAM 23, the I/O interface 24, via a system bus 19. The ROM 22 provides a main-storage area for the CPU 21, and prestores various programs including system programs for controlling the CPU 21, authentication programs, service providing programs, and the like. The CPU 21 retrieves these programs from the ROM 22 and expands the retrieved programs in the working area 23a of the RAM 23. In this manner, the CPU 21 executes, for example, an authentication process, a service providing process, and the like (described later).

The RAM 23 provides a main storage area for the CPU 21. The RAM 23 is a volatile memory which data is retrieved from and stored into. The RAM 23 could be a dynamic RAM (DRAM). The working area 23a is used when the CPU 21 executes various processes for temporarily storing necessary working data, intermediate files, and the like.

The registration list 23b is a list of device addresses of authentic terminals 50 that are authorized to receive the services from the service providing device. The device addresses are globally unique identifiers distinguishing each terminal 50 from any other terminals existing in the global area.

For example, when a terminal 50 is a portable telephone or personal digital assistant (PDA) provided with a Bluetooth interface for a radio communication, then a Bluetooth device (BD) address is a device address of the terminal 50. When a terminal 50 is a personal computer or a workstation that includes a LAN interface, then a media access control (MDC) address is a device address of the terminal 50. Both the BD address and the MAC address are identifiers that identify individual devices. The registration list 23b is updated and referred to in the service providing process to be described later.

The I/O interface 24 is for assisting data transmission among the input key 25, the display 26, the LAN unit 27, the radio communication unit 28, the printer unit 31, the scanner unit 32, the facsimile unit 33, the copy unit 34, and the like.

The input key 25 is provided on an operation panel (not shown) of the MFP 20 and used for inputting various commands and information. The input key 25 could be a pressing button or a button displayed on a touch panel on the display 26.

The display 26 could be a liquid crystal display or a plasma display that provides a touch panel having the input key 25.

The LAN unit 27 is for assisting data transmission between a LAN cable 40 and the CPU 21. For example, when the LAN is a bus type, then the LAN unit 27 would be IEEE802.3 standard 10BASE-T LAN board capable of transfer rate of 10 Mbps.

The radio communication unit 28 is a radio frequency (RF) module enabling a Bluetooth short-range communication using a radio wave. The radio communication unit 28 transfers data at the rate of 1 Mbps by spectrum spreading modulation in frequency hopping (FH) at a radio frequency of 2.4 GHz. The communication range is about 10 m, for example.

The antenna 29 is connected to the radio communication unit 28, and radiates an electric wave at a radio frequency of 2.4 GHz. The antenna 29 also receives an electric wave at a radio frequency of 2.4 GHz through the air, and transmits the received electric wave to the radio communication unit 28. The antenna 29 could be a laminated chip antenna formed of multilayer dielectricity.

The printer unit 31 provides a printing function for printing monochromatic or multicolored characters and images. When the CPU 21 receives process data from a terminal 50 via the LAN unit 27 or the radio communication unit 28, then the CPU 21 converts the process data into a certain data format and transmits the converted data to the printer unit 31, so that the printer unit 31 prints characters or images onto a predetermined recording sheet based on the received data.

The scanner unit 32 provides an image-retrieving function for retrieving monochromatic or multicolored characters or images. For example, the scanner unit 32 retrieves characters or images from original documents, and transmits corresponding image data to the CPU 21. The CPU 21 converts the image data into a predetermined data format and transmits to a terminal 50 via the LAN unit 27 or the radio communication unit 28.

The facsimile unit 33 provides a communication functions for transmitting and receiving monochromatic or multicolored images. For example, when the CPU 21 receives process data from a terminal 50 via the LAN unit 27 or the radio communication unit 28, the CPU 21 converts the process data into a predetermined data format and outputs the image to the facsimile unit 33. The facsimile unit 33 then transmits images or characters based on the data to a designated terminal 50. Also, upon reception of image data, the facsimile unit 33 outputs the image data to the CPU 21. The CPU 21 converts the image data into a predetermined data format, and then transmits the converted data to a terminal 50 via the LAN unit 27 or the radio communication unit 28.

The copy unit 34 provides a copy function for duplicating documents printed with monochromatic images or multicolor images.

The terminals 50 could be portable devices, such as portable telephones or PDA, provided with a Bluetooth radio interface, or personal computers or workstations provided with a LAN interface. The terminal 50 transmits its own device address that identifies the terminal 50 to the authentication device and also to the service providing device. The terminal 50 also requests the service providing device for various services.

The terminal 50 includes a wireless unit 51 and a control unit 55. The wireless unit 51 has the same configuration as the radio communication unit 28. That is, the wireless unit 51 transfers data at the rate of 1 Mbps by spectrum spreading modulation in frequency hopping at radio frequency of within 2.4 GHz. The communication range is about 10 m.

The control unit 55 includes a CPU, a ROM, and a RAM (not shown). A service requesting program and other programs are stored in the ROM. The CPU is capable of executing various processes. In addition, if the terminal 50 is a portable telephone, the terminal 50 also includes functions necessary for a telephone device. If the terminal 50 is a PDA, then the terminal 50 includes function required to a personal information device.

In the above described authentication system 100, the service providing device formed within the MFP 20 can provide various services to the terminals 50, such as printing service using the printer unit 31, facsimile service using the facsimile unit 33, and the like. However, terminals 50 that can receive such services from the service providing device are limited to authentic terminals 50 whose device addresses are listed in the registration list 23b. That is, requests from authentic terminals 50 for the services are accepted, whereas requests from unauthentic terminals 50 are rejected. The authentication device of the present embodiment performs registration of authentic terminals 50 in a manner to be described below.

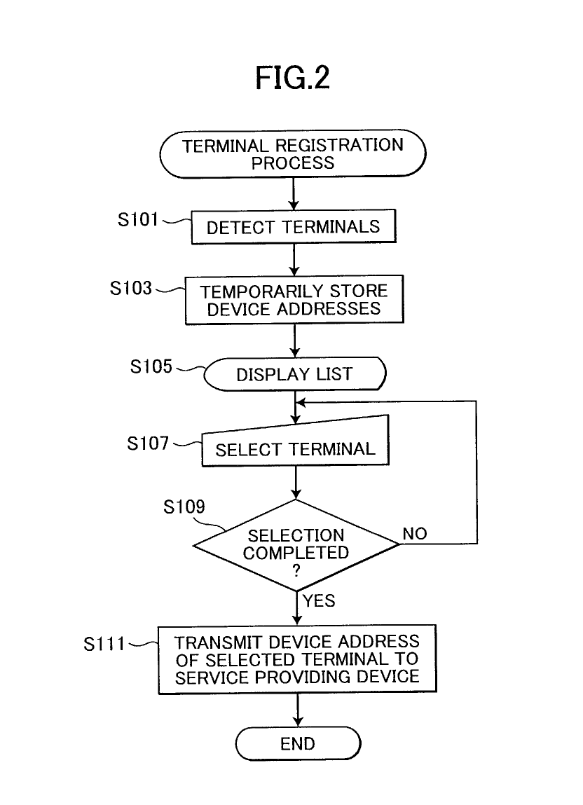

Next, processes executed in the certification system 100 will be described. First, a terminal registration process will be described while referring to the flowchart of FIG. 2.

The terminal registration process is executed by the authentication device for registering terminals 50 in the registration list 23b so as to enable selected terminals 50 to receive the services from the service providing device.

When the terminal registration process is started, necessary initializations are performed, and then in S101, terminals 50 that exist within a communication range and communicable with the MFP 20 are all searched for so as to retrieve device addresses of the terminals 50 in packets. Here, terminals 50 establishing a Bluetooth piconet can be searched for by transmitting an Inquiry command, for example. Terminals 50 connected to the LAN cable 40 of a certain domain, such as a collision domain or a broadcast domain, can be searched for by using Universal Plug and Play (UPnP) service discovery. In this manner, device addresses of all the communicable terminals 50 existing in the communication range are obtained without waiting for the terminals 50 to access the MFP 20.

Here, the UPnP is an architecture for network connectivity of telephone machines, personal computers, electric appliances, such as VCR, television sets, and digital cameras, and the like.

Next, in S103, the device addresses retrieved in S101 are temporarily stored in the working area 23a of the RAM 23.

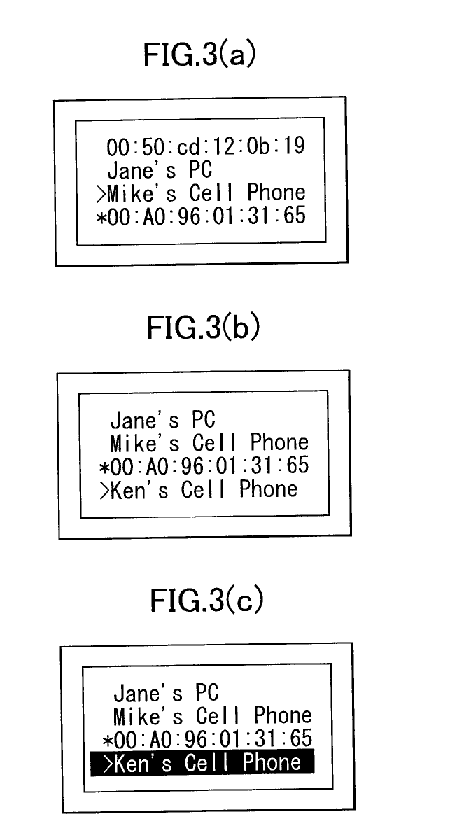

Then, in S105, a list of identification information is displayed on the display 26 as shown in FIG. 3(a). The identification information includes information texts and device addresses. “Mike's Cell Phone” and “Jane's PC” of FIG. 3(a) are examples of the information texts, and “00:A0:96:01:31:65” of FIG. 3(a) is an example of the device addresses. The identification text is a name of a corresponding terminal 50 associated with its device address for identifying the terminal 50. The identification text may be included in the packet that is received in S101 or may be already stored the RAM 23. The device addresses are displayed only if corresponding terminals 50 do not have the identification texts. If the list displayed in S105 is large for the display 26, then a scroll display shown in FIG. 3(b) can be displayed.

Next in S107, a user selects a terminal 50 to register as an authentic terminal while examining the list on the display 26. Specifically, the user places a cursor to identification information of a desired terminal 50 as shown in FIG. 3(a) by manipulating the input key 25 and presses an OK button through the input key 25. Then, the selected identification information is defined with white letters in black as shown in FIG. 3 (c). It should be noted that an asterisk shown in FIGS. 3(a) through 3(c) indicates that a corresponding terminal 50 is currently registered in the registration list 23b.

Next in S109, it is determined whether or not desired terminals 50 are all selected. If so (S109:YES), then the process proceeds to S111. On the other hand, if not (S109:NO), then the process returns to S107 to repeat the above processes, allowing the user to select more terminals 50. In S111, a device address(es) of the selected terminal(s) 50 is transmitted to the service providing device, then the present process ends.

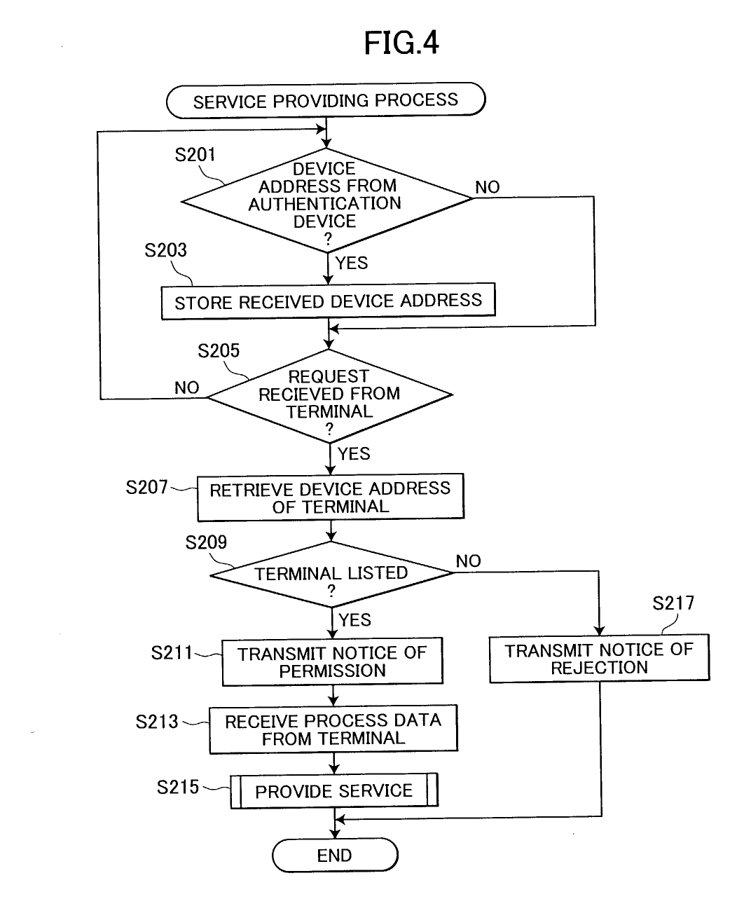

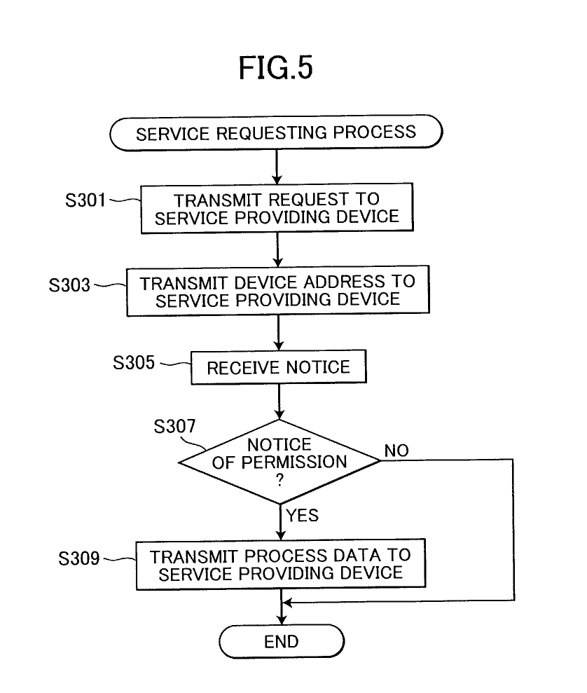

Next, a service providing process executed by the service providing device will be described while referring to the flowchart of FIG. 4. In the service providing process, the device address transmitted from the authentication device in S111 of FIG. 2 is added to the registration list 23b, and also services are provided to terminals 50 if the terminals 50 are confirmed authentic.

When the service providing process is started, necessary initializations are performed, and then in S201, the device address(es) transmitted from the authentication device in S111 of FIG. 2 is received. Then in S203, the received device address is added to the registration list 23b. In this manner, the corresponding terminal 50 is registered and thus authorized.

Next in S205, it is determined whether or not a request for service (service request) is received from a terminal 50. If not (S205:NO), then the process returns to S201. If so (S205:YES), then the process proceeds to S207 to receive a device address of the terminal 50. Then in S209, it is determined whether or not the received device address is included in the registration list 23b. If a negative determination is made in S209 (S209:NO), this means that the terminal 50 is not authentic, so that in S217 a notice of rejection is transmitted to the terminal 50, notifying the terminal that its request has been rejected. Then, the process ends.

On the other hand, if so (S209:YES), then this means that the terminal 50 is authentic, so that in S211 a notice of permission is transmitted to the terminal 50. Then in S213, process data is received from the terminal 50. The process data is an object of the request that the terminal 50 requests the service providing device to process. Then, in S215, the service, such as a printing service or a facsimile service, requested by the terminal 50 is provided, and then the process ends.

Next, a service requesting process executed in a terminal 50 is described while referring to the flowchart of FIG. 5. When the service requesting process starts, necessary initialization is performed, and then in S301, service request is transmitted to the service providing device. In this manner, an affirmative determination is made in S205 of FIG. 4.

Next in S303, a device address of the terminal 50 is transmitted to the service providing device. Thus transmitted device address is received by the service providing device in S207 of FIG. 4.

In S305, a notice transmitted from the service providing device in S211 or S217 of FIG. 3 is received. Then in S307, it is determined whether or not the notice is of permission. If so (S307:YES), then in S309, process data is transmitted to the service providing device, which receives the process data in S213, and the process ends.

On the other hand, if the notice is of rejection (S307:NO), this means that the terminal 50 is determined as an unauthentic terminal, so that the terminal 50 cannot receive the requested service. The process ends without executing S309.

As described above, according to the present embodiment, authentic terminals 50 allowed for receiving services can be easily registered in the registration list 23b without needing any help of system managers.

Also, because the identification information is displayed, a user can easily select one or more terminal 50 to register.

Also, once the user selects terminals 50, device addresses of the selected terminals 50 are transmitted to the service providing device and added to the registration list 23b. Accordingly, the service providing device can verify authenticity of a terminal 50 by referring to the registration list 23b, so that process time from receiving a service request from the terminal 50 until providing a requested service can be shortened.

According to the above embodiment, the authenticator transmits identifiers of selected terminal 50 to the service providing device. In this manner, the authenticator permits the service providing device to provided services to the selected terminals.

It should be noted that although in the above embodiment, the device address is transmitted in S303 of FIG. 5 only to the service providing device, the device address can be transmitted to the authentication device also, and then, the authentication device can execute processes of S103 to S111 of FIG. 1 upon reception of such a device address. In this manner, the terminal 50 can be registered in the registration list 23b when requests a service, without waiting for the authentication device to execute the above-described terminal search process of FIG. 3. Therefore, the authentication device can obtain a device address of a new terminal when the new terminal requests a service.

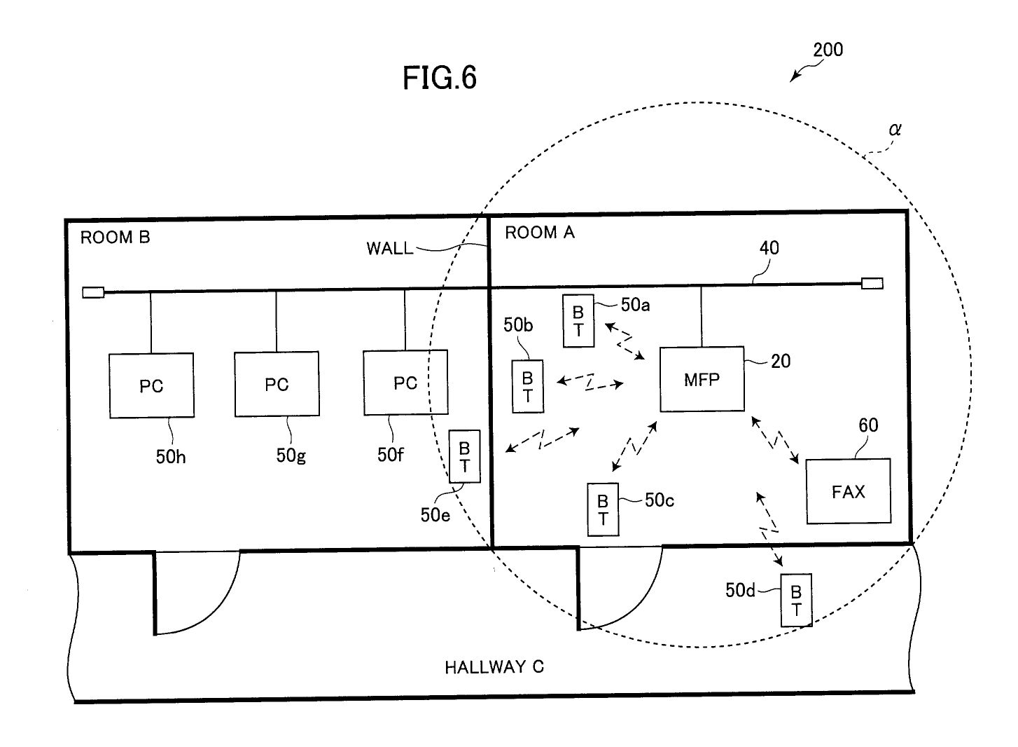

Next, a specific example of the above authentication system 100 will be described while referring to FIG. 6.

As shown in FIG. 6, a system 200 is provided in a room A and a room B divided by a wall. The room A is a restricted area that only limited persons are allowed to enter, and the room B is a public space that anyone is allowed to use. Both the rooms A and B are connected to a hallway C. Provided in the room A are the MFP 20 connected to the LAN cable 40 via a bus and a facsimile device 60 including a Bluetooth interface. Provided inside the room B are personal computers 50f, 50g, 50h, all connected to the LAN cable 40 connecting the rooms A and B. Further, a PDA 50d having a Bluetooth interface is located in the hallway C.

Now, portable telephones 50a, 50b and PDA 50c are inside the room A. Each of the portable telephone 50a, 50b and the PDA 50c is provided with a Bluetooth interface. In this condition, there is established a piconet where the MFP 20 serves as a master, and the portable telephones 50a, 50b and PDA 50c serve as slaves. If a communication range α of this piconet expands beyond the room A as shown in FIG. 6, the PDAs 50e and 50d within the communication range α could be slaves of the piconet because the PDA 50d and 50e have the Bluetooth interface. Further, because the LAN cable 40 to which the MFP 20 is connected is also connected to the personal computers 50f, 50g, 50h, the personal computers 50f, 50g, 50h could also establish a network by TCP/IP or the like.

That is, the MFP 20 establishes the piconet with the portable telephones 50a, 50b, the PDA 50c, 50d, 50e, and the facsimile device 60. At the same time, the MFP 20 establishes a network via the LAN cable 40 with the personal computers 50f, 50g, and 50h.

In such a network environment, even if the PDA 50d belongs to a person unauthorized for accessing the room A, he or she could receive services via the piconet from the MFP 20 using the PDA 50d within the communication range α outside the room A. In the similar manner, the users of the personal computers 50f, 50g, and 50h could receive the services from the MFP 20 regardless of whether or not the users are authorized to enter the room A. This is a serious security problem.

In order to overcome the above problems, the above described present invention could be used in the system 200. In this manner, only persons authorized both to enter the room A and to manipulate the MFP 20, i.e., users of the portable telephones 50a, 50b and the PDA 50c in this example, can register terminals 50 to the registration list 23b. In this manner, security of the system 200 is assured. Also, because the authorized persons can register desired terminal to the registration list 23b, the registration can be easily performed while reducing burden on a system manager.

Moreover, a person unauthorized to enter the room A cannot manipulate the MFP 20, so that the unauthorized person cannot register his terminal, such as the PDA 50d or 50e, to the registration list 23b. Therefore, even when the owner of the PDA 50d or 50e is within the communication range α in the hallway C or the next room B, the owner cannot receive services from the MFP 20 using the PDA 50d or 50e. Therefore, security is maintained without needing a system manager.

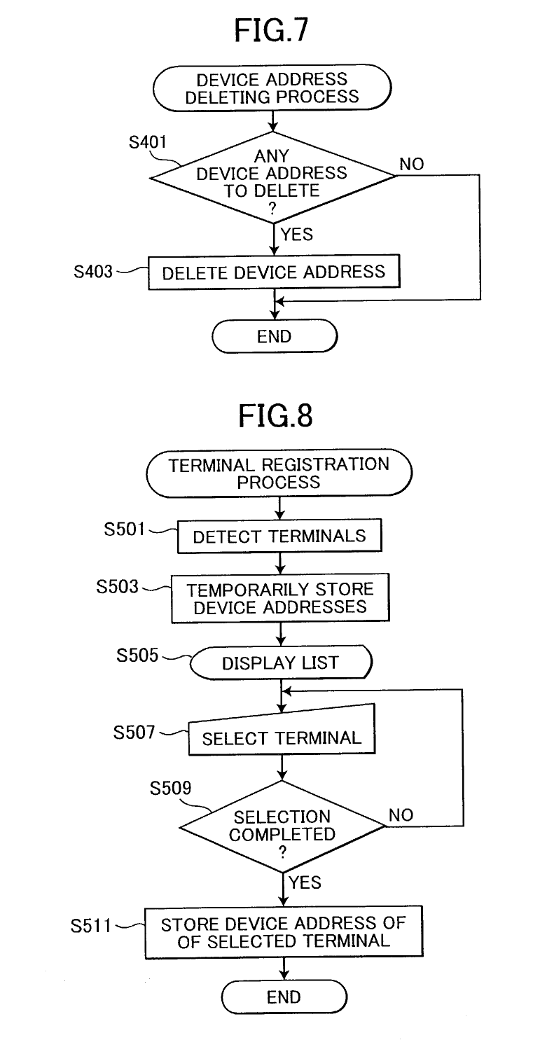

Next, a device address deleting process executed by the service providing device for deleting a device address from the registration list 23b will be described while referring to the flowchart of FIG. 7. The device address deleting process is an interrupting process regularly executed once in certain time duration.

When the device address deleting process starts, first necessary initialization processes are executed, and then in S401, it is determined whether or not there is any device address that can be deleted. This determination is made, for example, by detecting device addresses that have been registered for more than a predetermined time period.

If it is determined in S401 that there is a device address that can be deleted (S401:YES), then in S403 the device address is deleted, and the process ends. On the other hand, if a negative determination is made in S401 (S401:NO), then the process ends without executing the process of S403.

In this manner, a device address is deleted from the registration list 23b when a predetermined time elapses since the device address was registered. Therefore, a problem of that a terminal 50 is kept authorized forever once the terminal 50 is registered can be avoided. This improves security function.

It should be noted that the determination of S401 could be made based on, rather than passage of time, whether or not a data link between an authentic terminal 50 and the service providing device has been terminated, because a terminal 50 whose data link is terminated is no longer authorized to receive services from the MFP 20. In this manner also, the problem that a terminal 50 is kept authorized forever can be avoided.

Also, although in the above embodiment the device address selected in S111 is transmitted to a single service providing device, the device address could be transmitted to a plurality of service providing devices so that the plurality of service providing devices can use the device address. In this manner, a terminal allowed to receive service from the plurality of service providing devices can be registered in a simple manner.

Although in the above embodiment, the input key 25 and the display 26 are provided to the operation panel of the MFP 20, a personal computer or a computer terminal, for example, including a display means and a selection means could be provided independent from the MFP 20. In this manner, a variety of device configurations become possible, so that selected terminals can be registered in easier manner.

Next, an authentication system according to a second embodiment of the present invention will be described while referring to FIGS. 8 to 10. Because hardware components of the authentication system of the present embodiment is the same as the authentication system 100 of the first embodiment, their explanation will be omitted, and processes executed in the present embodiment will be described while referring to FIGS. 8 to 10.

In the present embodiment, unlike in the first embodiment, the registration list 23b is stored in the authentication device rather than the service providing device, and then the authentication device executes authentication using the registration list 23b when requested by the service providing device. Then, a determination result is transmitted to the service providing device.

Because a terminal 50 executes the same service requesting process as in the first embodiment represented in the flowchart of FIG. 5, an explanation thereof will be omitted.

Next, processes executed in the authentication system of the present embodiment will be described in detail. First, a terminal registration process executed by an authentication device according to the present embodiment will be described. As shown in the flowchart of FIG. 8, the terminal registration process of the present embodiment is similar to that of the first embodiment shown in FIG. 2, except a process in S511. That is, when the process starts, the processes same as that of S101 to S109 are executed in S501 through S509. Then, in S511, the device address of the selected terminal 50 is added to the registration list 23b stored in the RAM 23.

Because the device address of an authentic terminal 50 is added to the registration list 23b without being transmitted to the service providing device, the authentication device can manage all the device addresses. Also, there is no need to transmit the device addresses to the service providing devices. This makes easier to manage the device addresses and also simplifies the processes that the service providing device executes.

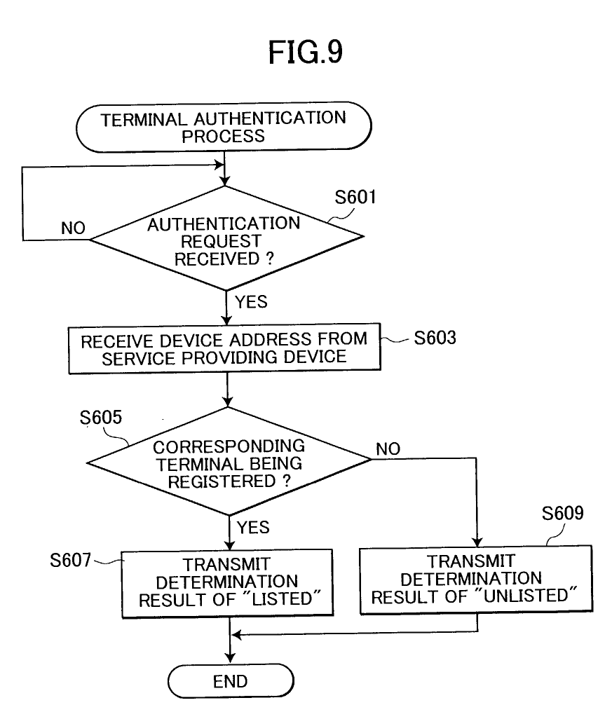

Here, it should be noted that a list of identification information could be displayed on the display 26 in S505 based on device addresses retrieved from the service providing device in S603 of FIG. 9 (described later).

Next, a terminal authentication process executed by the authentication device of the present embodiment will be described while referring to the flowchart shown in FIG. 9.

When the process starts, first in S601, it is determined whether or not an authentication request is received from the service providing device, the authentication request requesting the authentication device to verify authenticity of a subject terminal. If not (S601:NO), the process waits until any request is received. If so (S601:YES), then in S603 a device address of the subject terminal is retrieved from the service providing device. Next in S605, it is determined whether or not the received device address is listed in the registration list 23b, i.e., if the subject terminal 50 is registered in the registration list 23b. If so (S605:YES), then in S607, a determination result indicating “listed” is transmitted to the service providing device, and the process ends.

On the other hand, if a negative determination is made in S605 (S605:NO), then the process proceeds to S609. In S609, a determination result indicating “unlisted” is transmitted to the service providing device, and the process ends.

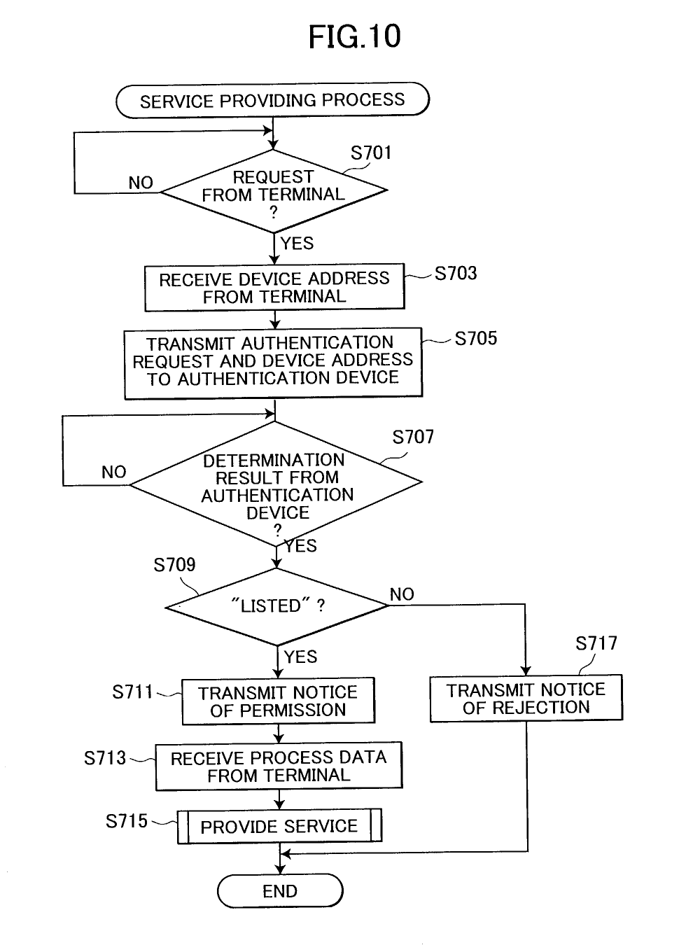

Next, a service providing process executed in the service providing device will be described while referring to the flowchart of FIG. 10.

When the process starts, first in S701, it is determined whether or not a service request is received from a terminal 50. Such a service request is transmitted in the process in S301 of FIG. 5. If not (S701:NO), then the process waits until a service request is received from any terminal 50. On the other hand, if so (S701:YES), then the process proceeds to S703. In S703, a device address transmitted from the terminal 50 in S301 of FIG. 5 is received. In this manner, the service providing device obtains the device address of the terminal 50 that requests services. Then, in S705, an authentication request and the obtained device address are transmitted to the authentication device for requesting authentication. As a result, an affirmative determination is made in S601 of FIG. 9, and a determination result is transmitted from the authentication device to the service providing device in S607 or S609.

In S707, it is determined whether or not a determination result is received from the authentication device. If not (S707:NO), then the process waits until the determination result is received. If so (S707:YES), then in S709, it is determined whether or not the received determination result indicates “listed”. If not (S709:NO), this means that the terminal 50 is unauthorized, so that in S717, a notice of rejection is transmitted to the terminal 50, and the process ends.

On the other hand, If so (S709:YES), this means that the terminal 50 is authorized, so that in S711 a notice of permission is transmitted to the terminal 50. Then, in S713, process data that is transmitted from the terminal 50 in S309 of FIG. 5 is received. In S715, the service requested by the terminal 50 is provided, and the process ends.

As described above, according to the present embodiment, the authentication device adds device addresses to the registration list 23b, so that all the device addresses can be easily managed using the authentication device, and there is no need to transmit the device addresses to the service providing device.

While some exemplary embodiments of this invention have been described in detail, those skilled in the art will recognize that there are many possible modifications and variations which may be made in these exemplary embodiments while yet retaining many of the novel features and advantages of the invention.

For example, in the above-described embodiments, the authentication device and the service providing device are provided in the single MFP 20. However, the authentication device could be provided independent from the service providing device. Also, the MFP 20 could be provided with only a single service providing device or more than one service providing devices.

What is claimed is:

1. An authentication system comprising:
a terminal assigned with an identifier that identifies the terminal;
an authentication device communicable with the terminal; and
a service providing device communicable both with the terminal and the authentication device, wherein
the terminal includes:
a first transmitting unit that transmits the identifier to the authentication device;
a second transmitting unit that transmits the identifier to the service providing device; and
a service requesting unit that requests the service providing device for a service;
the authentication device includes:
a display unit that displays identification information based on the identifier transmitted from the first transmitting unit;
a selecting unit that selects a terminal using the identification information displayed by the display unit; and
a third transmitting unit that transmits an identifier of the selected terminal to the service providing device;
the service providing device includes:
a memory that stores the identifier transmitted from the third transmitting unit;
a determination unit that determines whether or not the identifier transmitted from the second transmitting unit is being stored in the memory; and
a service providing unit that provides a requested service to a terminal if the determination unit determines that an identifier of the terminal is being stored in the memory.

2. The authentication system according to claim 1, wherein the authentication device further includes a searching unit that searched for the terminal, and the first transmitting unit transmits the identifier when the terminal is searched for by the searching unit.

3. The authentication system according to claim 1, wherein the first transmitting unit transmits the identifier when the service requesting unit requests the service providing device for the service.

4. An authentication device communicable with a service providing device that provides a service to a terminal if permitted, the authentication device comprising:
a display unit that displays identification information based on identifiers transmitted from terminals, each identifier identifying a corresponding terminal;
a selection unit that selects a terminal among the terminals based on the identification information; and
a permission unit that permits the service providing device to provide a service to the selected terminal by transmitting an identifier of the selected terminal.

5. The authentication device according to claim 3, wherein the permission unit that transmits the identifier of the selected terminal to a plurality of service providing devices.

6. The authentication device according to claim 4, further comprising a searching unit that searched for the terminals to retrieve identifiers of the terminals.

7. The authentication device according to claim 4, further comprising a receiving unit that receives an identifier of a terminal along with a service request from the terminal.

8. The authentication device according to claim 4, wherein the display unit and the selection unit are provided independent from the transmitting unit.

9. A service providing device comprising:
a memory that stores an identifier of a terminal transmitted from an authentication device;
a determination unit that determines whether or not an identifier of a subject terminal is stored in the memory;
a service providing unit that provides service to the subject terminal if the determination unit determines that the identifier of the subject terminal is stored in the memory.

10. The service providing device according to claim 9, further comprising a deleting unit that deletes an identifier from the memory when the identifier has been stored in the memory for a predetermined time period.

11. The service providing device according to claim 9, further comprising a deleting unit that deletes an identifier from the memory when a data link to a corresponding terminal is terminated.

12. An authentication system comprising:
a terminal assigned with an identifier that identifies the terminal;
a service providing device communicable with the terminal; and
an authentication device communicable with both the terminal and the service providing device, wherein
the terminal includes:
a first transmitting unit that transmits the identifier to the authentication device;
a second transmitting unit that transmits the identifier to the service providing device; and
a service requesting unit that transmits a service request requesting the service providing device for a service;
the service providing device includes:
a third transmitting unit that transmits the identifier from the second transmitting unit to the authentication device;
an authentication requesting unit that requests the authentication device for verify authenticity of a subject terminal by transmitting an identifier of the subject terminal to the authentication device; and
a service providing device that provides the service to the subject terminal;
the authentication device includes:
a display unit that displays identification information based on the identifier transmitted from at least one of the first transmitting unit and the third transmitting unit;
a selecting unit that selects a terminal using the identification information displayed by the display unit;
a memory that stores an identifier of the selected terminal;
a determination unit that determines whether or not an identifier of a subject terminal transmitted from the authentication requesting unit of the service providing device is being stored in the memory; and
a permitting unit that permits the service providing unit to provide the service to the subject terminal if the determination unit determines that the identifier of the subject terminal is being stored in the memory; wherein
the service providing unit provides the service to the subject terminal only when permitted by the permitting unit.

13. The authentication system according to claim 12, wherein the authentication device further includes a searching unit that searches for the terminal, and the first transmitting unit transmits the identifier when the terminal is searched for by the searching unit.

14. The authentication system according to claim 12, wherein the first transmitting unit transmits the identifier when the service requesting unit requests the service providing device for the service.

15. An authentication device communicable with a service providing device that provides a service to a terminal, the authentication device comprising:
a display unit that displays identification information based on identifiers transmitted from terminals and/or the service providing device;
a selecting unit that selects a terminal among the terminals based on the identification information displayed by the display unit;
a memory that stores an identifier of the selected terminal;
a determination unit that determines whether or not an identifier transmitted from a service providing device is being stored in the memory; and
a permission unit that permits the service providing device to provide the service to a subject terminal if the determination unit determines that an identifier of the subject terminal is being stored in the memory.

16. The authentication device according to claim 15, further comprising a deleting unit that deletes an identifier from the memory when the identifier has been stored for a predetermined time period.

17. The authentication device according to claim 15, further comprising a searching unit that searched for the terminals to retrieve identifiers of the terminals.

18. The authentication device according to claim 15, further comprising a receiving unit that receives an identifier of a terminal along with a service request from the terminal.

19. The authentication device according to claim 15, wherein the display unit and the selection unit are provided independent from the transmitting unit.

20. A service providing device comprising:
a receiving unit that receives a service request from a terminal;
a transmitting unit that transmits an identifier of the terminal to an authentication device, wherein the receiving unit further receives an authentication result from the authentication device that verifies authenticity of the terminal; and
a determination unit that determines whether or not to provide a service to the terminal based on the authentication result.

21. The service providing device according to claim 20, further comprising a deleting unit that deletes an identifier from the memory when a data link to a corresponding terminal is terminated.
